(19) United States
(12) Patent Application Publication
(10) Pub. No.: US 2014/0238353 A1
(43) Pub. Date: Aug. 28, 2014

(54) Apparatus and Method for Detecting Leakage of Liquid Fuel into Gas Fuel Rail

(71) Applicant: CATERPILLAR INC., Peoria, IL (US)

(72) Inventors: Cory A. Brown, Peoria, IL (US); Michael A. Brown, Peoria, IL (US); Steven Thomas Grant, Groveland, IL (US); Daniel Reese Puckett, Jr., Peoria, IL (US)

(73) Assignee: CATERPILLAR INC., Peoria, IL (US)

(21) Appl. No.: 13/778,343

(22) Filed: Feb. 27, 2013

(51) Int. Cl. F02M 51/06

(52) U.S. Cl. CPC F02M 51/06
USPC 123/458

(57) ABSTRACT

Methods and systems for detecting leakage of a liquid fuel into a gas fuel rail of a dual-fuel system for an internal combustion engine are disclosed. The methods and systems include sending an injection signal from a controller to a fuel injector and subsequently injecting gas fuel and liquid fuel into a cylinder for combustion. A pressure in the gas rail detects the pressure in the gas rail over a pre-determined time period after the injection event. A controller measures pressure fluctuations in the gas rail over a pre-determined time period after the injection event. If the pressure in the gas rail fluctuates by more than the pre-determined amount, the controller is programmed to take at least one mitigating action to prevent or limit damage to the engine.

### TECHNICAL FIELD

This disclosure relates generally to dual fuel common rail systems, and more particularly to a diesel only method of operation that includes strategies to address liquid fuel leakage into the gas fuel side of the system.

### BACKGROUND

Diesel engines are the most popular type of compression ignition engines. Diesel engines introduce fuel directly into the combustion chamber. Diesel engines are very efficient because they provide high compression ratios without knocking, which is the premature detonation of the fuel mixture inside the combustion chamber. Because diesel engines introduce fuel directly into the combustion chamber, the fuel injection pressure must be greater than the pressure inside the combustion chamber. For liquid fuels such as diesel, the pressure must be significantly higher so that the fuel is atomized for efficient combustion.

Diesel engines are favored by industry because of their excellent combination of power, performance, efficiency and reliability. For example, diesel engines are generally much less expensive to operate compared to gasoline fueled, spark-ignited engines, especially in commercial applications where large quantities of fuel are used. However, one disadvantage of diesel engines is pollution, such as particulate matter (soot) and NOx gases, which are subject to increasingly stringent regulations that require NOx emissions to be progressively reduced over time. To comply with these increasingly stringent regulations, engine manufacturers are developing catalytic converters and other after-treatment devices to remove pollutants from diesel exhaust streams.

Improvements to diesel fuels are also being introduced to reduce the amount of sulfur in diesel fuel, to prevent sulfur from de-activating the catalysts of catalytic converters and to reduce air pollution. Research is also being conducted to improve combustion efficiency to reduce engine emissions, for example by making refinements to engine control strategies. However, most of these approaches add to the capital cost of the engine and/or the operating costs.

Other recent developments have been directed to substituting some of the diesel fuel with cleaner burning gas fuels such as, for example, natural gas, methane, butane, propane, hydrogen, and blends thereof. Since gas fuels typically do not auto-ignite at the same temperature and pressure as diesel fuel, a small amount of pilot diesel fuel can be introduced into the combustion chamber to auto-ignite and trigger the ignition of the gas fuel. Another approach for consuming gas fuel on board a vehicle involves introducing the gas fuel into the engine's intake air manifold at relatively low pressures. However, this approach has been unable to match the performance and efficiency of currently available diesel engines, particularly at high gas:diesel ratios. Thus, fuel injectors have been developed that provide a simultaneous delivery of both diesel fuel and gas fuel to combustion chambers, with the diesel acting as a pilot fuel.

For example, U.S. Pat. No. 7,627,416 appears to teach a dual fuel common rail system in which liquid diesel fuel and natural gas fuel are both injected from a single fuel injector associated with each engine cylinder. This reference recognizes that there may be instances in which the engine will need to operate solely on liquid diesel fuel due to exhaustion of the natural gas fuel supply or possibly some fault in the natural gas portion of the system. However, one problem this reference does not recognize is the migration of diesel or the liquid fuel into the gas fuel delivery system or gas rail. If liquid fuel migrates or leaks into the gas rail, the gas:liquid fuel ratio changes, engine performance suffers and damage to the engine is possible.

### SUMMARY

Thus, there is a need for a methods and systems for detecting when liquid fuel has leaked or migrated into the gas rail so the operation of the engine can be changed to mitigate or prevent damage and/or so the operator can be notified that such a problem exists.

In one aspect, a method for detecting leakage of a liquid fuel into a gas rail of a dual-fuel system for an internal combustion engine is disclosed. The method may include sending an injection signal from the controller to a fuel injector and injecting gas fuel and liquid fuel into a cylinder for combustion. The method may further include detecting the pressure in the gas rail over a pre-determined time period after the injection event. The method may further include measuring pressure fluctuations in the gas rail over the pre-determined time period and, if the pressure in the gas rail fluctuates by more than the pre-determined amount, the method may further include taking at least one mitigating action.

In another aspect, a system for detecting leakage of a liquid fuel into a supply of a gas fuel of a dual-fuel internal combustion engine is disclosed. The system may include a gas rail that is coupled to a pressure sensor. The gas rail may also be in communication with a gas nozzle chamber of a fuel injector for delivering gas fuel to the gas nozzle chamber. The system may also include a liquid rail in communication with a liquid nozzle chamber of the fuel injector for delivering a liquid fuel to the liquid fuel chamber. Further, the system may include a controller linked to the pressure sensor. The controller may have a memory programmed to receive signals from the pressure sensor and to determine if the pressure in the gas rail is fluctuating more than the pre-determined amount. The memory may also be programmed to initiate a mitigating action if the pressure in the gas rail is fluctuating more than the pre-determined amount.

A vehicle is also disclosed which may include an engine which may include a plurality of cylinders and a plurality of fuel injectors. Each cylinder may be in communication with one of the fuel injectors. Each fuel injector may include a liquid nozzle chamber and a gas nozzle chamber for simultaneously injecting liquid fuel and gas fuel respectively into its respective cylinder. Each fuel injector may also be in communication with a gas rail and a liquid rail. The gas rail may be used for delivering gas fuel from a gaseous fuel tank to the plurality of fuel injectors. The liquid rail may be used for delivering liquid fuel from a liquid fuel tank to the plurality of fuel injectors. The gas rail may be coupled to a pressure sensor. The pressure sensor may be linked to the controller. The controller may have a memory programmed to receive signals from the pressure sensor and to determine if a pressure in the gas rail is fluctuating more than a pre-determined amount. The memory may also be programmed to initiate a mitigating action if the pressure in the gas rail is fluctuating more than a pre-determined amount.

### BRIEF DESCRIPTION OF THE DRAWINGS

FIG. 1 is a schematic view of a dual fuel engine according to this disclosure.

FIG. 2 is a sectional perspective view of a portion of the engine housing shown to reveal a structure for one quill assembly, a disclosed fuel injector and an engine cylinder.

FIG. 3 is a sectional side view through the co-axial quill assembly shown in FIG. 2.

FIGS. 4-9 are sectional views through a disclosed fuel injector.

FIG. 10 graphically illustrates the differences in the pressure waves or fluctuations generated by an injection event with no liquid in the gas rail and with liquid in the gas rail.

### DESCRIPTION

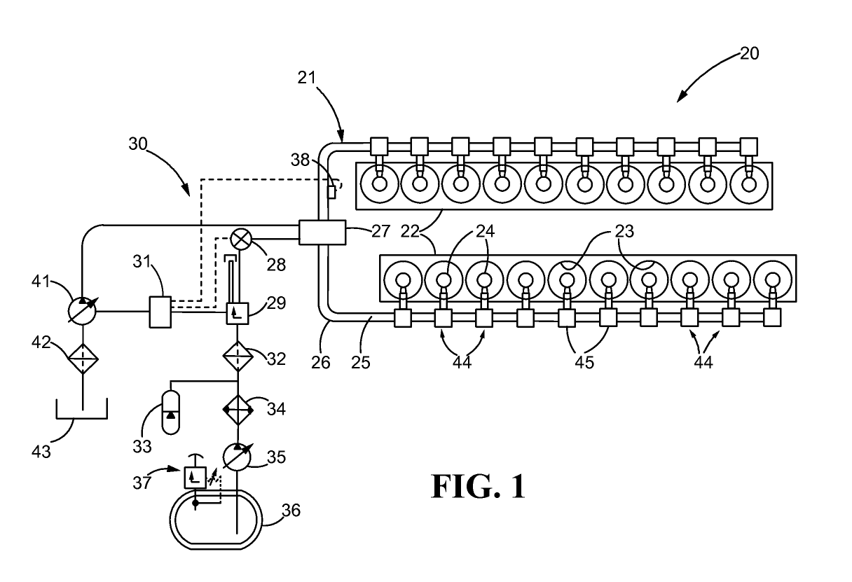

Referring initially to FIGS. 1-3, a dual fuel engine 20 may include a dual fuel common rail system 21 mounted to an engine block 22 that may define a plurality of engine cylinders 23. Each cylinder 23 may include a fuel injector 24 positioned for direct injection into each its respective cylinder 23. A gas fuel common rail 25 and a liquid fuel common rail 26 may be fluidly connected to each fuel injector 25 and therefore each cylinder 23.

The gas fuel common rail 25 may be in communication with a manifold 27 which may be in communication with an isolation valve 28. The isolation valve 28 may be used to shut off the gas fuel supply in the event that the gas fuel pressure drops to an undesirable level and the engine 20 must convert to a “limp home” mode where the engine 20 runs on liquid fuel only. The isolation valve 28 may be connected to a fuel conditioning module 29 which may be linked with the isolation valve 28 to the controller 31. The controller 31 may be an engine control module (ECM). A filter 32, an accumulator 33, a pump 35 and a pressurized cryogenic gas fuel tank 36 may be disposed upstream of the conditioning module 29. The fuel tank 36 may be equipped with a pressure relief valve 37. The controller 31 may also be linked to a gas fuel rail pressure sensor 38 that monitors the pressure in the gas rail 25.

The liquid fuel common rail 26 may also be in communication with a manifold 27 which may be in communication with a high pressure fuel pump 41. The fuel pump 41 may be linked to the controller 31 and may also be disposed upstream or downstream from a filter 42. In the embodiment shown in FIG. 1, the pump 41 draws liquid fuel from a liquid fuel tank 43 and through the filter 42 before delivering the liquid fuel to the manifold 27 and the liquid fuel common rail 26.

The controller 31 may control each fuel injector 24, the isolation valve 28, the fuel conditioning module 29, and the pump 41 in a known manner. The gas fuel pump 35 may be a unidirectional variable displacement cryogenic pump while the liquid fuel pump 41 may be a unidirectional variable displacement hydraulic pump. The fuel conditioning module 29 may be used to control the supply and pressure of gas fuel to gas fuel common rail 25.

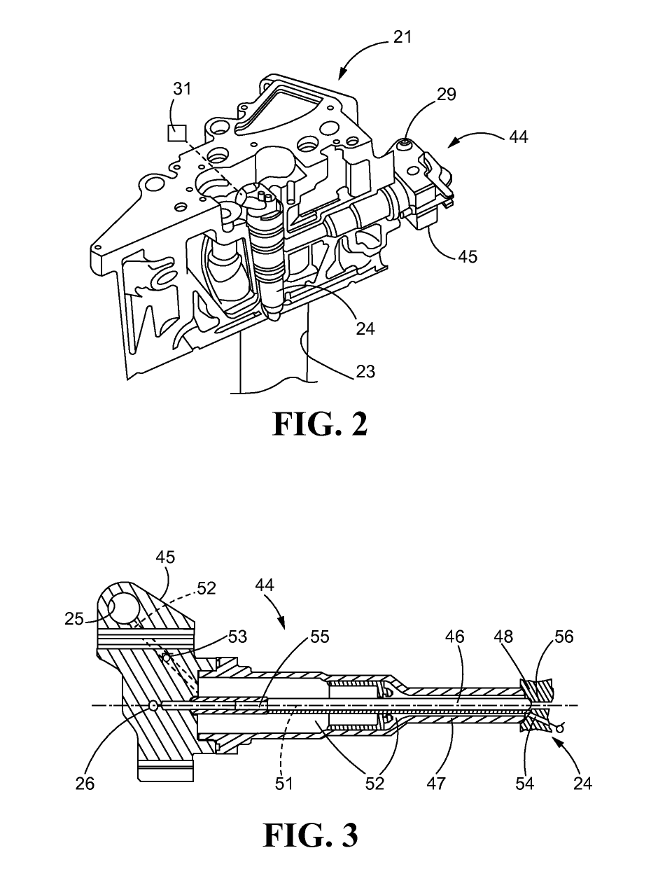

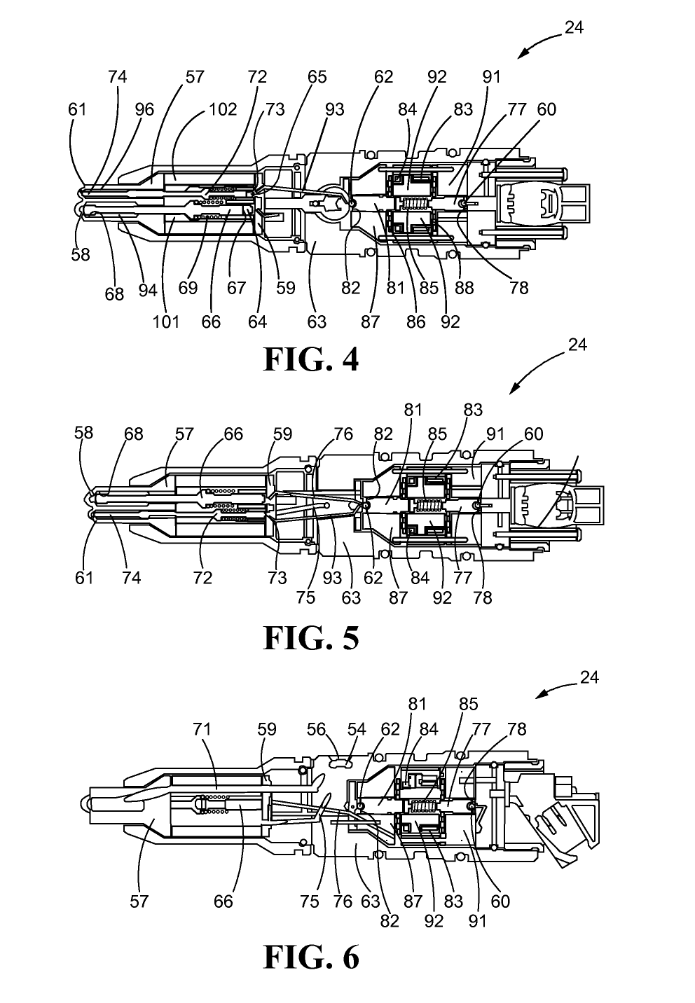

Turning to FIGS. 1-3, a cylinder 23 is shown coupled to a fuel injector 24 which, may be coupled to a coaxial quill assembly 44. As shown in FIG. 1, each cylinder 23 may be associated with its own quill assembly 44, and as shown in FIGS. 1-2, each quill assembly 44 may include a block 45. Turning to FIG. 3, the co-axial quill assembly 44 may include an inner quill 46 and an outer quill 47 in sealing contact with a common conical seat 48 of each fuel injector 25 (see also FIG. 2). The blocks 45 of the co-axial quill assemblies 44 may be coupled together by the gas fuel rail 25 and the liquid fuel rail 26. The blocks 45 may also be in communication with the fuel conditioning module 29 as shown in FIG. 2. It will be noted here that the gas fuel rail 25 and liquid fuel rail 26 need not be unitary structures but may be segments coupled together at the various blocks 45.

Each block 45 of each co-axial quill assembly 44 may define a segment of the gas common rail 25 which may be oriented perpendicular to the axis 51 of the inner quill 46. One end of a gas fuel passage 52 opens at the gas fuel common rail 25, proceeds through the check valve 53, passes between the inner quill 46 and the outer quill 47 before opening at its other end into the gas fuel inlet 54 of the fuel injector 24. Thus, a segment of the gas fuel rail 25 is located between the inner quill 46 and the outer quill 47. Each of the blocks 45 also defines a segment of liquid fuel common rail 26. One end of a liquid fuel passage 55 opens at the liquid common rail 26, and may open at its opposite end into liquid fuel inlet 56 of the fuel injector 24.

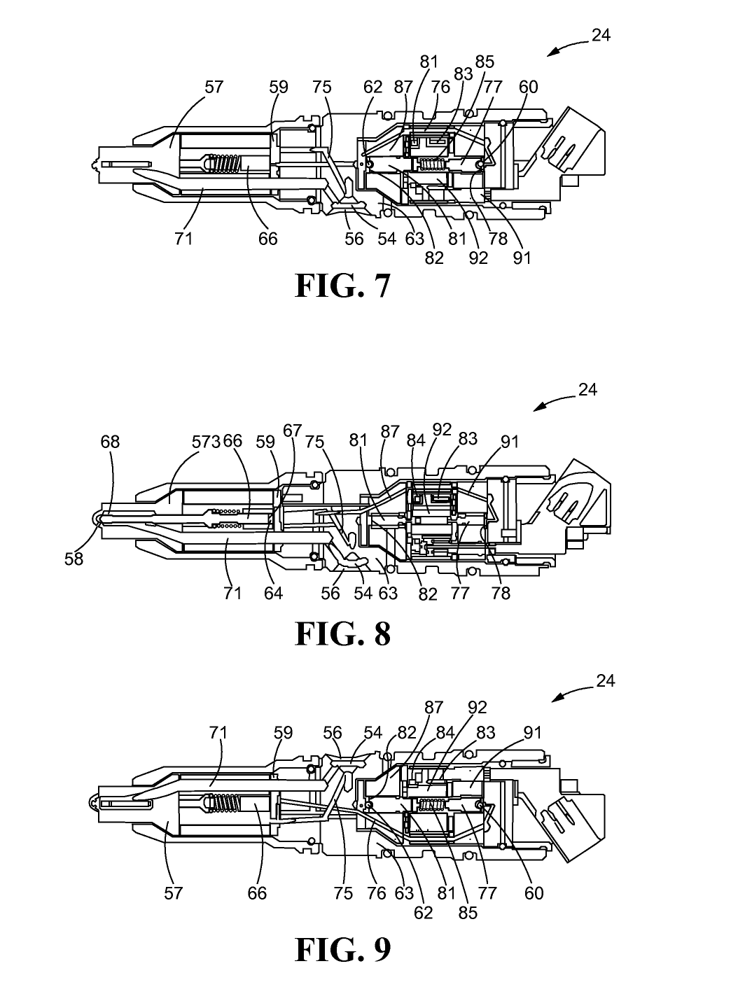

Referring to FIGS. 4-9 and primarily to FIG. 4, a disclosed fuel injector 24 may include a nozzle body 57 that defines a gas nozzle outlet 58 and a liquid nozzle outlet 61. The injector 24 may include an injector body 63 coupled to the nozzle body 57 and that defines a liquid drain outlet 62 and a gas drain outlet 60. The injector body 63 may also define the gas fuel inlet 54 and the liquid fuel inlet 56, which can be seen in FIG. 3 opening through the common seat 48 of fuel injector 24. The gas and liquid fuel inlets 54, 56 are also shown in FIGS. 6-9.

Returning to FIG. 4, the injector body 63 may include a gas control chamber 64 and a liquid control chamber 65 defined by the plate 59 and closing hydraulic surfaces 67, 73 of a gas check valve 66 and a liquid check valve 72 respectively. The closing hydraulic surface 67 is exposed to fluid (gas) pressure in the gas control chamber 64. The gas check valve 66 is movable between a closed position, as shown in FIGS. 4-9, in contact with a gas seat 68 to fluidly block flow from the gas fuel inlet 54 (FIG. 3 and FIGS. 6-9) to the gas nozzle outlet 58, and an open position (not shown) out of contact with the gas seat 68 to fluidly connect the gas fuel inlet 54 (FIG. 3 and FIGS. 6-9) to the gas nozzle outlet 58.

The liquid check valve 72 has a closing hydraulic surface 73 (FIG. 4) exposed to fluid pressure in the liquid control chamber 65. The liquid check valve 72 may also be movable between a closed position, as shown in FIGS. 4-9, in contact with a liquid seat 74 to fluidly block the liquid fuel inlet 56 to the liquid nozzle outlet 61, and an open position out of contact with the liquid seat 74 to fluidly connect the liquid fuel inlet 56 to the liquid nozzle outlet 61 via a liquid supply passage 75 not visible in FIG. 4 but shown in FIGS. 5-9.

Thus, an injection of a gas fuel (e.g., natural gas) to a cylinder 23 through the gas nozzle outlet 58 is facilitated by movement of the gas check valve 66, while an injection of a liquid fuel (e.g., diesel) through the liquid nozzle outlet 61 is facilitated by movement of the liquid check valve 72. Those skilled in the art will appreciate that the gas and liquid nozzle outlets 58, 61 might be expected to each include several nozzle outlets arranged around respective centerlines in a manner well known in the art. However, the gas and liquid nozzle outlets 58, 61 could each include as few as one nozzle outlet or any number of nozzle outlets in any arrangement without departing from the scope of this disclosure.

A gas control valve 77 may be positioned in the injector body 63 and may be movable axially between a closed position in contact with a seat 78 at which the gas control chamber 64 is fluidly blocked from the gas drain outlet 60, and an open position where the gas control chamber 64 is fluidly connected to the gas drain outlet 60 via the control passage 76 as shown in FIGS. 5-7 and 9. When the gas control chamber 64 is fluidly connected to gas drain outlet 60 in the open position, pressure in gas control chamber 64 drops, relieving pressure on the closing hydraulic surface 67 to allow the gas check valve 66 to lift with the assistance of the spring or biasing element 69 to facilitate an injection of the gas fuel (e.g. natural gas) through the gas nozzle outlet 58.

A liquid control valve 81 may be positioned in the injector body 63 and movable axially between a closed position in contact with a seat 82 so the liquid control chamber 65 is fluidly blocked from the liquid drain outlet 62 as shown in FIG. 4, and an open position out of contact with the seat 82 at which the liquid control chamber 65 is fluidly connected to the liquid drain outlet 62 via the liquid control passage 93 as shown in FIGS. 4-5. When the liquid control chamber 65 is fluidly connected to liquid drain outlet 62, fluid pressure acting on the closing hydraulic surface 73 is relieved to allow the liquid check valve 72 to lift to an open position to facilitate injection of the liquid fuel (e.g., diesel) through the liquid nozzle outlet 61.

In the illustrated embodiment, the gas and liquid control valve members 77, 81 may be moved to one of their respective closed and open positions with the gas and liquid electrical actuators 83, 84 respectively. The control valves 77, 81 may be biased to their closed position by a spring(s) or biasing member(s) 85. A liquid armature 86 may be attached to a pusher 87 in contact with the liquid control valve 81. The liquid armature 86, the pusher 87 and the liquid control valve 81 may be biased to the position shown in contact with the seat 82 by the spring 85. Thus, the liquid armature 86 can be thought of as being operably coupled to move the liquid control valve 81. Similarly, a gas armature 88 may be operably coupled to move the gas control valve 77 by way of the pusher 91. A common stator 92 separates the liquid armature 86 from the gas armature 88.

The liquid control valve 81 may be in contact and out of contact with the seat 82 in its open and closed positions respectively. Likewise, the gas control valve 77 may be in contact and out of contact with the seat 78 in its closed and open positions, respectively. The liquid control valve 81 may be coupled to move with the liquid armature 86 in response to a de-energizing of the liquid actuator 84 mounted in the common stator 92. When the liquid actuator 84 is energized, the armature 86 and pusher 87 are lifted upward (or shifted to the right in FIGS. 4-9) thereby allowing the high pressure in control passage 93 (FIGS. 4-5) to push the liquid control valve 81out of contact with the seat 82 to fluidly connect the liquid control chamber 65 to drain outlet 62.

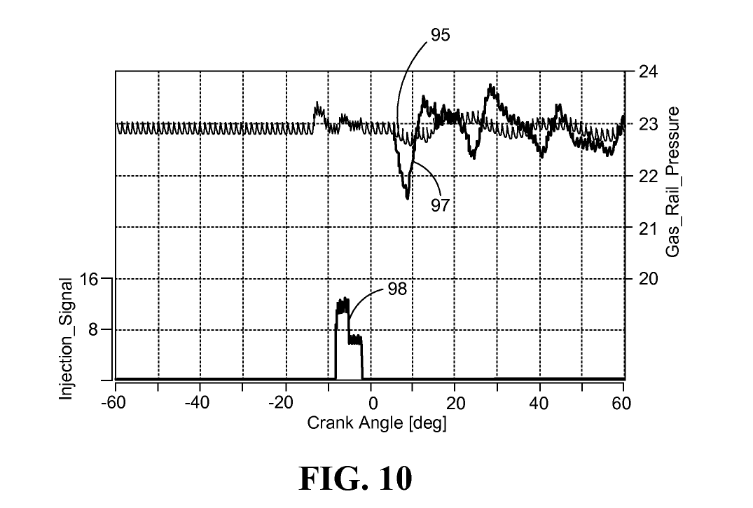

The gas nozzle chamber 94 may be fluidly connected to gas fuel inlet 54 via the passage 71 (see FIGS. 6-9). The liquid nozzle chamber 96 may be fluidly connected to the liquid fuel inlet 56 via the liquid fuel supply passage 75 (see FIGS. 5-9). Some amount of leakage of liquid fuel may occur from the liquid nozzle chamber 96 into the gas nozzle chamber 94 during a regular mode of operation. However, substantial leakage may cause damage to the engine 20 and various components thereof. In one aspect, a method for determining when such leakage occurs may include detecting fluctuations in the pressure in the gas common rail 25 as shown in FIG. 10 and discussed below.

Dual fuel common rail fuel systems may also have a single fuel mode of operation in which only liquid diesel fuel is utilized to power the engine 20. This mode of operation may be referred to as a “limp home” mode, as this mode of operation may only be preferable when there is some fault in the gas fuel system. A fault may include a malfunction of one or more of gas supply pressure control devices such as the pressure relief valve 37, the pump 35, the heat exchanger 34, the filter 32, the fuel conditioning module 29 or the isolation valve 28. A malfunction may also simply relate to a lack of sufficient gas fuel in the tank 36 to continue operating in a regular mode. When operating in a limp home mode, the controller 31 may maintain the liquid rail 26 at a high pressure (e.g., 80 MPa), whereas the pressure in gas rail 25 may be allowed to decay, and may slowly drop as low as atmospheric pressure.

During the limp home mode, the engine 20 is operated as a conventional diesel engine in which liquid diesel fuel is injected through the liquid nozzle outlets 61 in sufficient quantities and at timings to compression ignite the liquid fuel. On the other hand, during the regular mode of operation, one might expect a relatively small pilot liquid injection through the liquid nozzle outlets 61 to be compression ignited to ignite a much larger charge of gas fuel injected through gas nozzle outlets 58 to power the engine 20 in a regular mode of operation. Due to the higher pressure differential between the liquid fuel and the gas fuel that exists during the limp home mode of operation, more leakage of liquid fuel from the upper liquid nozzle chamber 102 to the gas nozzle chamber 94 is expected as opposed to a regular mode of operation with a smaller pressure differential between the two fuels.

Referring back to FIG. 1, although not necessary, the dual fuel common rail system 30 may also include an electronically controlled isolation valve 28 operably positioned between the fuel conditioning module 29 and the manifold 27. The isolation valve 28 may be mechanically biased toward a closed position but movable to an open position responsive to a control signal from the controller 31. When the dual fuel common rail fuel system 21 is being operated in a regular mode, the electronic controller 31 may maintain the isolation valve 28 in an open position. However, in the event that the system transitions into a limp home mode of operation, the electronic controller 31 may close the isolation valve 28 to fluidly isolate the gas supply from any leaked liquid fuel that may find its way into the gas side of dual fuel common rail system 21. As an alternative, a mechanical check valve may be employed to isolate the gas supply from the dual fuel common rail system 21.

Turning to FIG. 10, the line 95 represents the pressure in the gas common rail 25 during a normal operation. However, the line 97 represents the pressure in the gas common rail 25 when a significant leakage of liquid fuel into the gas common rail 25 has occurred. As noted above, such leakage may predominantly occur between liquid nozzle chamber 102 and the gas nozzle chamber 94. Accordingly, detection of the pressure spikes and drops in the gas common rail 25 as shown by the line 97 provides a means for detecting when leakage of liquid fuel into the gas common rail 25 is occurring or has recently occurred. The reader will note that the spikes and drops in gas rail 25 may occur after an injection signal is sent by the controller 31 as indicated by the line 98. The magnitude of the wave may be indicative of the amount of liquid fuel that has leaked into the gas rail 25.

Further, while leakage from the liquid nozzle chamber 96 to the gas nozzle chamber 94 may be the primary location where liquid fuel leaks into the gas rail 25, other areas of the disclosed injectors 24 and other fuel injectors that differ in design from the disclosed injector 24 may be the source of such leakage and those skilled in the art will be able to examine a fuel injector design and determine where such leakage may occur.

### INDUSTRIAL APPLICABILITY

A system and method for detecting liquid fuel leakage from the liquid rail 26 to the gas rail 25 is disclosed. When such leakage occurs, the pressure in the gas rail 25 will fluctuate and such fluctuations can be detected by the gas rail pressure sensor 38 and may be communicated to the controller 31. The gas rail pressure sensor 38 may be in continuous or regular communication with the controller 31.

Therefore, a dual fuel system is disclosed that is configured to: (1) monitor the pressure in the gas rail 25; (2) evaluate pressure waves in the gas rail 25 after injections to determine if liquid fuel is present in the gas rail 25; and (3) take one or more mitigating actions. Detecting liquid fuel or diesel in the gas rail 25 will allow the engine controller 31 to take any one or more of the following mitigating actions, such as: (1) entering a diagnostic mode to determine the leak location; (2) entering a liquid fuel or diesel only mode operation; (3) reducing fuel delivered to the effected cylinder(s) to prevent or reduce engine damage; (4) derating the engine or reducing the power output of the engine to prevent engine damage; and/or (5) notifying the operator that a problem exists. The controller 31 may be programmed to take other corrective actions as well, as will be apparent to those skilled in the art.

1. A method for detecting leakage of a liquid fuel into a gas rail of a dual fuel system for an internal combustion engine, the method comprising:
sending an injection signal from a controller to a fuel injector;
injecting gas fuel and liquid fuel into a cylinder for combustion;
detecting pressure in the gas rail over a predetermined time period after the injecting;
measuring pressure fluctuations in the gas rail over the predetermined time period; and
if the pressure in the gas rail fluctuates by more than a predetermined amount, taking at least one mitigating action.

2. The method of claim 1 wherein the at least one mitigating action includes determining a location of the leakage of liquid fuel into the gas rail.

3. The method of claim 1 wherein the at least one mitigating action includes entering a liquid fuel only operating mode.

4. The method of claim 3 wherein the entering of the liquid fuel only operating mode includes shutting an isolation valve disposed between a gas fuel tank and the gas rail.

5. The method of claim 1 wherein the at least one mitigating action includes reducing a power output of the engine.

6. The method of claim 1 wherein the at least one mitigating action includes sending a signal to an operator indicating a malfunction.

7. The method of claim 1 wherein the at least one mitigating action includes sending a signal to an operator indicating that leakage of liquid fuel into the gas rail is occurring.

8. The method of claim 1 wherein the gas fuel is liquefied natural gas (LNG).

9. The method of claim 1 wherein the liquid fuel is diesel.

10. A system for detecting leakage of a liquid fuel into a supply of a gas fuel of a dual fuel internal combustion engine, the system comprising:
a gas rail, the gas rail being coupled to a pressure sensor, the gas rail in communication with a gas nozzle chamber of a fuel injector for delivering a gas fuel to the gas nozzle chamber;
a liquid rail in communication with a liquid nozzle chamber of the fuel injector for delivering a liquid fuel to the liquid fuel chamber;
a controller linked to the pressure sensor, the controller having a memory programmed to receive signals from the pressure sensor and determine if a pressure in the gas rail is fluctuating more than a predetermined amount, the memory also programmed to initiate a mitigating action if the pressure in the gas rail is fluctuating more than the predetermined amount.

11. The system of claim 10 wherein the predetermined amount is a fluctuation that occurs in the gas rail after an injection when the gas rail is liquid-fuel free.

12. The system of claim 10 further including an isolation valve disposed between a gas fuel tank and the gas rail and the at least one mitigating action includes the controller sending a signal to the isolation valve that closes the isolation valve.

13. The system of claim 10 wherein the at least one mitigating action includes reducing a power output of the engine.

14. The system of claim 10 wherein the at least one mitigating action includes sending a signal to an operator indicating a malfunction.

15. The system of claim 10 wherein the at least one mitigating action includes sending a signal to an operator indicating that leakage of liquid fuel into the gas rail is occurring.

16. The system of claim 10 wherein the gas fuel is liquefied natural gas (LNG).

17. The system of claim 10 wherein the liquid fuel is diesel.

18. A vehicle comprising:
an engine including a plurality of cylinders and a plurality of fuel injectors, each cylinder in communication with one of the fuel injectors, each fuel injector including a liquid nozzle chamber and a gas nozzle chamber for simultaneously injecting liquid fuel and gas fuel respectively into its respective cylinder, each fuel injector in communication with a gas rail and a liquid rail, the gas rail for delivering gas fuel from a gaseous fuel tank to the plurality of fuel injectors, the liquid rail for delivering liquid fuel from a liquid fuel tank to the plurality of fuel injectors;
the gas rail being coupled to a pressure sensor, the pressure sensor being linked to a controller, the controller having a memory programmed to receive signals from the pressure sensor and determine if a pressure in the gas rail is fluctuating more than a predetermined amount, the memory also programmed to initiate a mitigating action if the pressure in the gas rail is fluctuating more than the predetermined amount.

19. The vehicle of claim 18 wherein the predetermined amount is a fluctuation that occurs in the gas rail after an injection when the gas rail is liquid-fuel free.

20. The vehicle of claim 18 further including an isolation valve disposed between a gas fuel tank and the gas rail and the at least one mitigating action includes the controller sending a signal to the isolation valve that closes the isolation valve.
